(19) United States
(12) Patent Application Publication
(10) Pub. No.: US 2025/0236465 A1
(43) Pub. Date: Jul. 24, 2025

(54) Lifting Device for Cylindrical Container and Method thereof

(71) Applicant: Javid Rouhi, Springfield, VA (US)

(72) Inventor: Javid Rouhi, Springfield, VA (US)

(21) Appl. No.: 18/418,117

(22) Filed: Jan. 19, 2024

(51) Int. Cl. B65G 7/12

(52) U.S. Cl. CPC B65G 7/12

(57) ABSTRACT

A lifting device (100) including a first arcuate member (102) coupled with a first sleeve (104), which has a first cut-out at a radial mid-section of the first arcuate member (102), such that, a first handle (106) extends from the radial mid-section. The lifting device (100) further includes a second arcuate member (108) coupled with a second sleeve (110), which has a second cut-out at a radial mid-section of the second arcuate member (108), such that, a second handle (112) extends from the radial mid-section. The lifting device (100) further include an adjustable hinge (114) coupled between a first end of the first arcuate member (102) and a first end of the second arcuate member (108). The lifting device (100) further includes a toggle latch clamp (116) coupled between a second end of the first arcuate member (102) and a second end of the second arcuate member (108).

### TECHNICAL FIELD

The present disclosure relates to a lifting mechanism. More particularly, the present disclosure relates to a system and a method to lift a cylindrical container, such as a gas cylinder.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

Gas cylinders may generally be lifted via several lifting mechanisms. The lifting mechanism may typically include a pair of circular members that may be configured to be coupled to the cylindrical container via a lock. Based on the engagement of the lock, the cylindrical container may be lifted via a grip of the locked circular members. However, in certain instances, the cylindrical containers may be damaged due to the frictional lock of the circular members of the lifting mechanism against the cylindrical container. Further, in other instances, it may be difficult for the operator to engage the lock between the pair of cylindrical members of the lifting mechanism. Hence, there is a need for an improved lifting mechanism that addresses the abovementioned problems.

The present disclosure is directed to overcome one or more limitations stated above or any other limitations associated with the prior art.

### SUMMARY OF THE INVENTION

The following presents a simplified summary to provide a basic understanding of some aspects of a lifting device. This summary is not an extensive overview and is intended to neither identify key or critical elements nor delineate the scope of such elements. Its purpose is to present some concepts of the described features in a simplified form as a prelude to the more detailed description that is presented later.

An exemplary aspect of the disclosure may provide a lifting device (100) to lift a cylindrical container. The lifting device (100) may include a first arcuate member (102), wherein the first arcuate member (102) is coupled with a first sleeve (104), the first sleeve (104) has a first cut-out at a radial mid-section of the first arcuate member (102), such that, a first handle (106) extends from the radial mid-section of the first arcuate member (102), via the first cut-out of the first sleeve (104). The lifting device (100) may further include a second arcuate member (108), wherein the second arcuate member (108) is coupled with a second sleeve (110), the second sleeve (110) has a second cut-out at a radial mid-section of the second arcuate member (108), such that, a second handle (112) extends from the radial mid-section of the second arcuate member (108), via the second cut-out of the second sleeve (110). The lifting device (100) may further include an adjustable hinge (114) coupled between a first end of the first arcuate member (102) and a first end of the second arcuate member (108), wherein the adjustable hinge (114) is configured to swivel between the first end of the first arcuate member (102) and the first end of the second arcuate member (108). The lifting device (100) may further include a toggle latch clamp (116) coupled between a second end of the first arcuate member (102) and a second end of the second arcuate member (108), wherein the toggle latch clamp (116) is configured to adjust a screw distance between the second end of the first arcuate member (102) and the second end of the second arcuate member (108).

Another exemplary aspect of the disclosure may provide a method of forming a lifting device (100) to lift a cylindrical container. The method may include disposing a first arcuate member (102), wherein the first arcuate member (102) is coupled with a first sleeve (104), the first sleeve (104) has a first cut-out at a radial mid-section of the first arcuate member (102), such that, a first handle (106) extends from the radial mid-section of the first arcuate member (102), via the first cut-out of the first sleeve (104). The method may further include disposing a second arcuate member (108), wherein the second arcuate member (108) is coupled with a second sleeve (110), the second sleeve (110) has a second cut-out at a radial mid-section of the second arcuate member (108), such that, a second handle (112) extends from the radial mid-section of the second arcuate member (108), via the second cut-out of the second sleeve (110). The method may further include coupling an adjustable hinge (114) between a first end of the first arcuate member (102) and a first end of the second arcuate member (108), wherein the adjustable hinge (114) is configured to swivel between the first end of the first arcuate member (102) and the first end of the second arcuate member (108). The method may further include coupling a toggle latch clamp (116) between a second end of the first arcuate member (102) and a second end of the second arcuate member (108), wherein the toggle latch clamp (116) is configured to adjust a screw distance between the second end of the first arcuate member (102) and the second end of the second arcuate member (108).

It is to be understood that the aspects and embodiments of the disclosure described above may be used in any combination with each other. Several of the aspects and embodiments may be combined to form a further embodiment of the disclosure.

The above summary is provided merely for the purpose of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### OBJECTS OF THE INVENTION

The main object of the present disclosure is to form a lifting device that shall not damage the cylindrical containers.

Another object of the present disclosure is to form a lifting device that shall be easily coupled to the cylindrical containers during a lifting operation.

### Effects/Advantages of the Present Invention

One of the advantages of the present disclosure is a minimal wear and tear on a surface of the cylindrical container due to a presence of sleeves (such as the first sleeve (104), and the second sleeve (110) on the lifting device (100).

Another advantage of the present disclosure is a quick engagement of the lifting device (100) with the cylindrical container based on the coupling of at least one of: the toggle latch clamp (116) or the adjustable hinge (114).

### BRIEF DESCRIPTION OF THE DRAWINGS

The accompanying drawings, which are incorporated in and constitute a part of this disclosure, illustrate exemplary embodiments and, together with the description, explain the disclosed principles.

FIG. 1 illustrates an isometric view of a lifting device, in accordance with an embodiment of the disclosure.

FIG. 2 illustrates an isometric view of a lifting device, in accordance with another embodiment of the disclosure.

FIG. 3 illustrates an isometric view of a toggle latch clamp of the lifting device as shown in FIG. 1 or FIG. 2, in accordance with an embodiment of the disclosure.

FIG. 4 is a flowchart of a method to form the lifting device shown in FIG. 1 or FIG. 2, in accordance with an embodiment of the disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

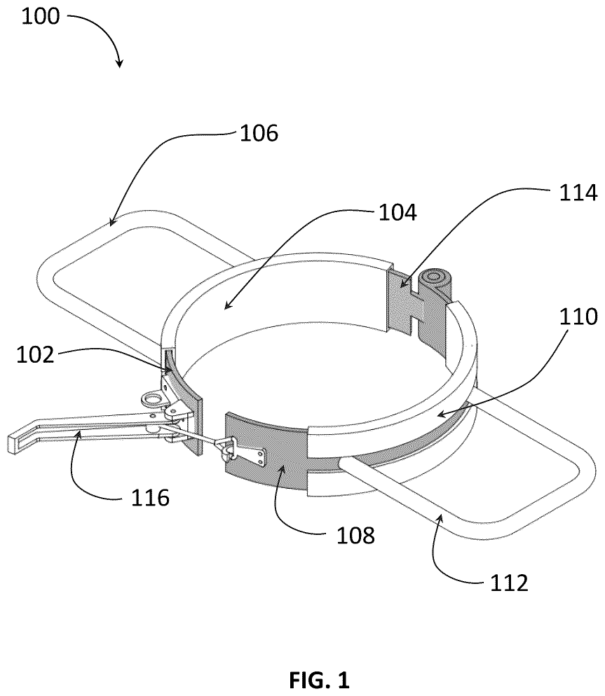

FIG. 1 illustrates an isometric view of a lifting device, in accordance with an embodiment of the disclosure. With reference to FIG. 1, there is shown a lifting device (100). The lifting device (100) includes a first arcuate member (102), a first sleeve (104) enclosing the first arcuate member (102), and a first handle (106) coupled to the first arcuate member (102). The lifting device (100) further includes a second arcuate member (108), a second sleeve (110) enclosing the second arcuate member (108), and a second handle (112) coupled to the second arcuate member (102). The lifting device (100) further includes an adjustable hinge (114) that couple with one end of the first arcuate member (102) and the second arcuate member (108). The lifting device (100) further includes a toggle latch clamp (116) that couple with another end of the first arcuate member (102) and the second arcuate member (108).

The lifting device (100) may generally be used to lift cylindrical containers. The cylindrical containers may include, but not limited to, a gas cylinder, a liquid canister, or any other container that has a substantially cylindrical shape. In certain instances, it may be difficult to lift such cylindrical containers by bare hands of an operator due to lack of frictional connect between the operator and the cylindrical container. Hence, the lifting device (100) is used to couple with such cylindrical containers, so that, the operator may easily lift and transport the cylindrical containers from one location to another location.

The first arcuate member (102) may include a suitable design, shape and structure which may be configured to hold a part of the cylindrical container. In an embodiment, the first arcuate member (102) may be made from a metallic material, such as, the stainless steel. In another embodiment, the first arcuate member (102) may be made from at least one of: a polymeric material, a composite material, and the like. The first arcuate member (102) may be formed based on one of: a forging process, a casting process, and the like. The first arcuate member (102) may generally be formed from a light weight and high strength material, which shall be configured to withstand a weight of the cylindrical container. In another embodiment, the first arcuate member (102) has an Ultimate Tensile Strength (UTS) of about 518 MPa to 520 MPa, a Yield Stress (YS) of about 375 MPa to 377 MPa and Youngs Modulus (E) of about 23.5% to 24%. Further, the first arcuate member (102) has a width of 1½″ and a thickness of ⅛″. The first arcuate member (102) may have substantially C-shaped structure. However, one skilled in the art may understand that the first arcuate member (102) may also have other shapes and dimensions without deviating from the scope of the disclosure. Examples of such shapes may include a substantially hexagonal, decagonal, or polygonal profile, based on user requirements. In an embodiment the first arcuate member (102) may be coupled with the first sleeve (104).

The first sleeve (104) may include suitable shape, design, and structure, which may be configured to secure the first arcuate member (102). In an embodiment, the first sleeve (104) may be formed from a material that may be different from the material of the first arcuate member (102). For example, in case the first arcuate member (102) is formed from a metallic material, the first sleeve (104) may be formed from a polymeric material, which may function as a cushion between the first arcuate member (102) and the surface of the cylindrical container. In another example, in case the first arcuate member (102) is formed from a metallic material, the first sleeve (104) may be formed based on a liquid glue, which may function as a cushion between the first arcuate member (102) and the surface of the cylindrical container. Therefore, there may not be any damage on the cylindrical container during transportation, via the lifting device (100).

In an embodiment, the first sleeve (104) may have a first cut-out at a radial mid-section of the first arcuate member (102), such that, the first handle (106) extends from the radial mid-section of the first arcuate member (102), via the first cut-out of the first sleeve (104).

The first handle (106) may include a suitable shape, design, and structure, which may be configured to facilitate a grip for an operator to lift the lifting device (100). The first handle (106) is located substantially perpendicular to an axis of the cylindrical container, such that, a load of the cylindrical container is uniformly distributed on the first handle (106), and it may be easier for the operator to lift the cylindrical container from one location to another location. Referring to FIG. 1, it may be shown that the first handle (106) has a substantially rectangular profile. However, one skilled in the art may understand that the first handle (106) may have any other shape without deviating from the scope of the disclosure. Examples off such shapes of the first handle (106) may include, but not limited to, a substantially arcuate handle, a triangular handle, a wavy handle, or a polygonal handle.

The second arcuate member (108) may include a suitable design, shape and structure which may be configured to hold a rest of the cylindrical container. In an embodiment, the second arcuate member (108) may be made from a metallic material, such as, the stainless steel. In another embodiment, the second arcuate member (108) may be made from at least one of: a polymeric material, a composite material, and the like. The second arcuate member (108) may be formed based on one of: a forging process, a casting process, and the like.

In an embodiment, the first arcuate member (102) is formed from a material that may be same as a material of the second arcuate member (108). In another embodiment, the first arcuate member (102) may be formed from a material that may be different from a material of the second arcuate member (108).

The second arcuate member (108) may generally be formed from a light weight and high strength material, which shall be configured to withstand a weight of the cylindrical container. In another embodiment, the second arcuate member (108) has an Ultimate Tensile Strength (UTS) of about 518 MPa to 520 MPa, a Yield Stress (YS) of about 375 MPa to 377 MPa and Youngs Modulus (E) of about 23.5% to 24%. Further, the first arcuate member (102) has a width of 1½″ and a thickness of ⅛″. The second arcuate member (108) may have substantially C-shaped structure. However, one skilled in the art may understand that the second arcuate member (108) may also have other shapes without deviating from the scope of the disclosure. Examples of such shapes may include a substantially hexagonal, decagonal, or polygonal profile, based on user requirements. As the first arcuate member (102) have the first C-shaped structure, and the second arcuate member (108) have the second C-shaped structure, when the first arcuate member (102) is coupled with the second arcuate member (108), it forms a substantially circular structure that conforms to a circumference of the cylindrical container. In an embodiment, the second arcuate member (108) may be coupled with the second sleeve (110).

The second sleeve (110) may include suitable shape, design, and structure, which may be configured to secure the second arcuate member (108). In an embodiment, the second sleeve (110) may be formed from a material that may be different from the material of the second arcuate member (108). For example, in case the second arcuate member (108) is formed from a metallic material, the second sleeve (110) may be formed from a polymeric material, which may function as a cushion between the second arcuate member (108) and the surface of the cylindrical container. In another example, in case the second arcuate member (108) is formed from a metallic material, the second sleeve (110) may be formed based on a liquid glue, which may function as a cushion between the second arcuate member (108) and the surface of the cylindrical container. Therefore, there may not be any damage on the cylindrical container during transportation, via the lifting device (100).

In an embodiment, the second sleeve (110) may have a second cut-out at a radial mid-section of the second arcuate member (108), such that, the second handle (112) extends from the radial mid-section of the second arcuate member (108), via the second cut-out of the second sleeve (110).

In another embodiment, the first sleeve (104) or the second sleeve (110), may formed from a same material as a material one of: the first arcuate member (102) or the second arcuate member (108). In yet another embodiment, at least one of: the first sleeve (104) or the second sleeve (110), may be formed from a material, which may be different from a material of one of: the first arcuate member (102) or the second arcuate member (108).

The second handle (112) may include a suitable shape, design, and structure, which may be configured to facilitate a grip for an operator to lift the lifting device (100). The second handle (112) is located substantially perpendicular to an axis of the cylindrical container, such that, a load of the cylindrical container is uniformly distributed on the second handle (112), and it may be easier for the operator to lift the cylindrical container from one location to another location. Referring to FIG. 1, it may be shown that the second handle (112) has a substantially rectangular profile. However, one skilled in the art may understand that the second handle (112) may have any other shape without deviating from the scope of the disclosure. Examples off such shapes of the second handle (112) may include, but not limited to, a substantially arcuate handle, a triangular handle, a wavy handle to grip each finger of the operator, or a polygonal handle.

The adjustable hinge (114) has a suitable design, shape, and structure, which may be configured to control swiveling between the first arcuate member (102) and the second arcuate member (108). In an embodiment, the adjustable hinge (114) may be formed from a metallic material, which may be fixedly coupled between the first arcuate member (102) and the second arcuate member (108). In another embodiment, the adjustable hinge (114) may be removably coupled between the first arcuate member (102) and the second arcuate member (108). It may be noted, though it is not shown, there may also be a control mechanism (for example, a slotted rail and releasable latch, such that, the swiveling may be controlled based on the releasable latch and its engagement with at least one slot of a plurality of slots of the slotted rail) in the adjustable hinge (114), which may be configured to adjust the swiveling between the first arcuate member (102) and the second arcuate member (108).

In an embodiment, the adjustable hinge (114) is coupled between a first end of the first arcuate member (102) and a first end of the second arcuate member (108). The adjustable hinge (114) may be configured to adjust the swiveling between the first end of the first arcuate member (102) and the first end of the second arcuate member (108)

In another embodiment, the adjustable hinge (114) may be a living hinge, which may be formed from a same material as a material one of: the first arcuate member (102) or the second arcuate member (108).

In yet another embodiment, the adjustable hinge (114) may be formed from a material, which may be different from a material of one of: the first arcuate member (102) or the second arcuate member (108).

The toggle latch clamp (116) has a suitable design, shape, and structure, which may be configured to control the screw distance between the first arcuate member (102) and the second arcuate member (108). In an embodiment, to lift a cylindrical container, the operator may engage the first arcuate member (102) on one surface (for example, a left surface) of the cylindrical container. Based on the engagement of the first arcuate member (102), the operator may couple the second arcuate member (108) on another surface (for example, a right surface opposed to the left surface) of the cylindrical container. Based on the engagement, the toggle latch clamp (116) may be configured to latch the first arcuate member (102) with the second arcuate member (108), to form a firm grip of the lifting device (100) against the circumference of the cylindrical container. Based on confirmation of firm grip, the operator may use the lifting device (100) to easily lift the cylindrical container from one location to another location.

In an embodiment, toggle latch clamp (116) has a hook and a tongue-based latch, the hook is configured to receive a tongue-based latch and couple the second end of the first arcuate member (102) with the second end of the second arcuate member (108).

In another embodiment, the toggle latch clamp (116) may be formed from a same material as a material one of: the first arcuate member (102) or the second arcuate member (108). In an alternate embodiment, the toggle latch clamp (116) may be formed from a material, which is different from a material one of: the first arcuate member (102) or the second arcuate member (108).

The toggle latch clamp (116) may be coupled between a second end of the first arcuate member (102) and a second end of the second arcuate member (108). The toggle latch clamp (116) may be configured to adjust the screw distance between the second end of the first arcuate member (102) and the second end of the second arcuate member (108).

In an embodiment, a swiveling angle of the adjustable hinge (114) may varies in a range between 10 degrees to 90 degrees.

In yet another embodiment, the swiveling angle and the screw distance may be adjusted based on a dimension of the cylindrical container. For example, if the dimension of the cylindrical container requires the swiveling angle to be changed, the operator may control the lifting device (100) to control the swiveling angle. In another example, if the dimension of the cylindrical container requires the screw distance to be changed, the operator may control the lifting device (100) to control the screw distance. In yet another example, if the dimension of the cylindrical container requires both the swiveling angle and the screw distance to be changed, the operator may control the lifting device (100) to adjust both the swiveling angle and the screw distance.

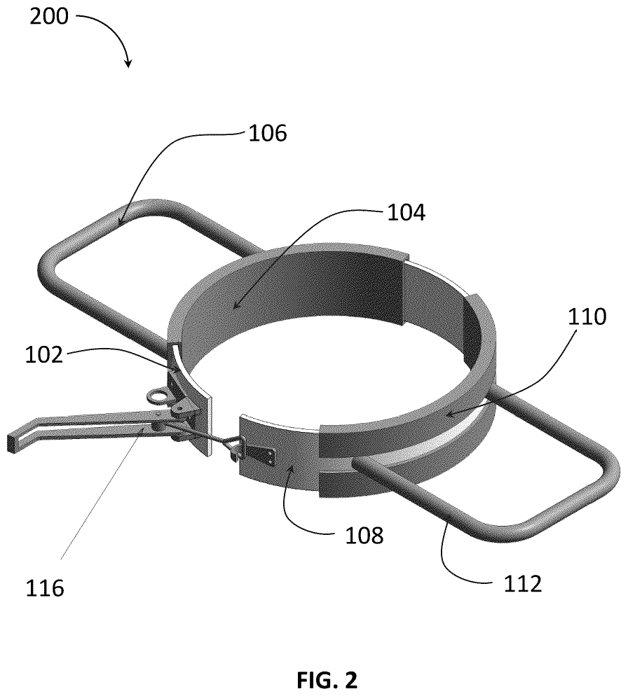

FIG. 2 illustrates an isometric view of a lifting device, in accordance with another embodiment of the disclosure. FIG. 2 is described in conjunction with reference from FIG. 1. With reference to FIG. 2, there is shown a lifting device (200).

The lifting device (200) has a suitable design, shape, and structure, which may be substantially similar to functional aspects of the lifting device (100). However, the lifting device (200) may be hinge-less or has a living-hinge, which may be integrally coupled to one of: the first arcuate member (102) or the second arcuate member (108).

In an embodiment, the adjustable hinge (114) is integrated with at least one of: the first arcuate member (102) or the second arcuate member (108) to form the lifting device (200). Such design of the lifting device (200) may be cost-effective to manufacture. Further, as there are minimal movable components in the lifting device (200), there may be minimal wear and tear in the lifting device (200), which may further improve lifetime of the lifting device (200). During operation, the toggle latch clamp (116) may be used to expand the first arcuate member (102) and the second arcuate member (108) and accommodate the cylindrical container in the lifting device (200).

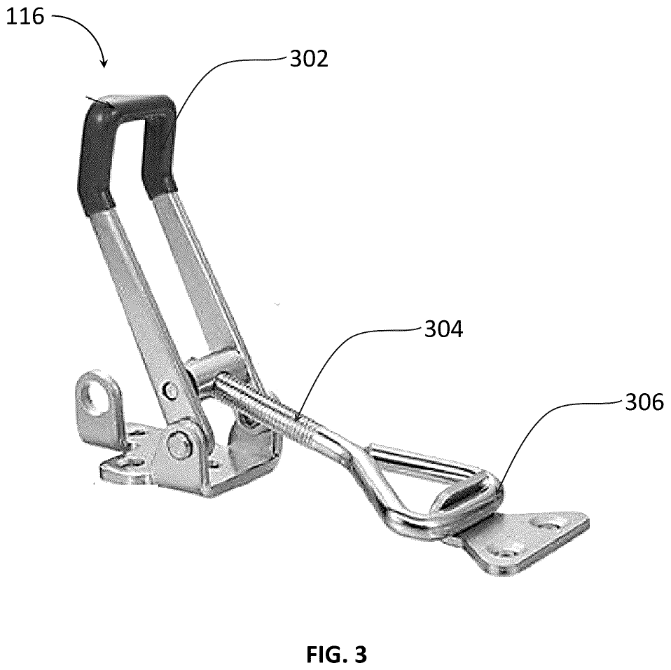

FIG. 3 illustrates an isometric view of a toggle latch clamp of the lifting device as shown in FIG. 1 or FIG. 2, in accordance with an embodiment of the disclosure. FIG. 3 is described in conjunction with reference from FIG. 1 and FIG. 2. With reference to FIG. 3, there is shown the toggle latch clamp (116).

The toggle latch clamp (116) may include a latch (302), a screw-based adjustment mechanism (304), and a hook lock (306). The hook lock (306) may be configured to engage the second end of the first arcuate member (102) with the second end of the second arcuate member (108). Based on the engagement, the screw-based adjustment mechanism (304) is configured to adjust the screw distance between the first arcuate member (102) and the second arcuate member (108), based on user requirements and dimensions of the cylindrical container, such that, the adjustment of the screw distance forms a grip of the lifting device (100) against the cylindrical container. Based the formation of the grip, the latch (302) may be engaged to lock the movement of the screw-based adjustment mechanism (304). Based on the engagement of the latch (302) of the toggle latch clamp (116), the operator may easily lift the cylindrical container, via the lifting device (100).

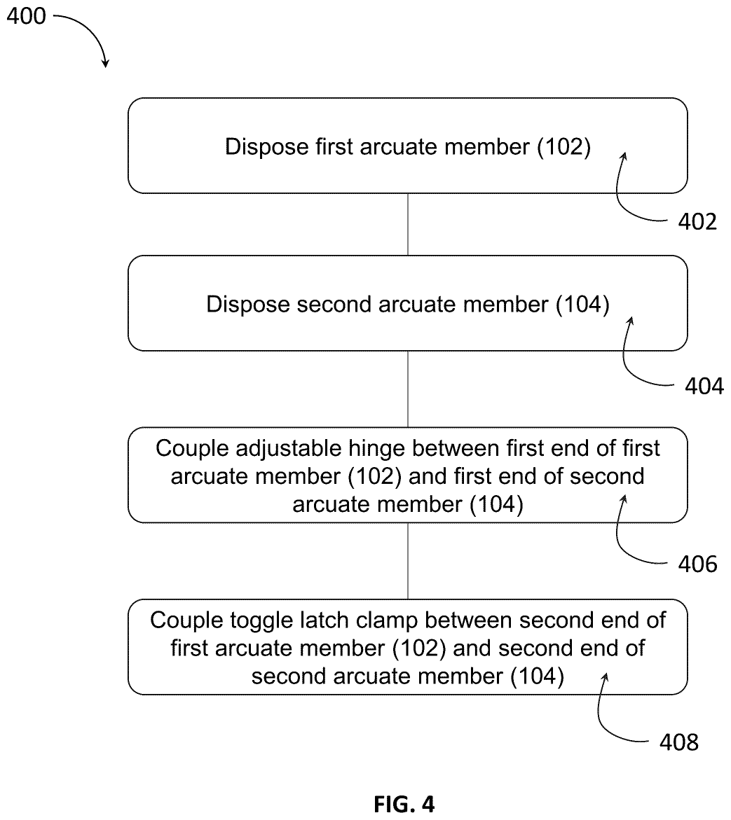

FIG. 4 is a flowchart of a method to form the lifting device shown in FIG. 1 or FIG. 2, in accordance with an embodiment of the disclosure. FIG. 4 is described in conjunction with reference from FIG. 1, FIG. 2, and FIG. 3. With reference to FIG. 4, there is shown a flowchart (400) that may correspond to a method of forming a lifting device (100). Further, for ease of explanation, in the embodiments described below, the method may be implemented by an operator or a manufacturer, as described with reference to FIG. 1. The method illustrated in the flowchart may start from step (402).

At step (402), the first arcuate member (102) may be disposed. In an embodiment, the operator or the manufacturer may dispose the first arcuate member (102), as described for example, in FIG. 1.

At step (404), the second arcuate member (108) may be disposed. In an embodiment, the operator or the manufacture may dispose the second arcuate member (108), as described for example, in FIG. 1.

At step (406), the adjustable hinge (114) may be coupled between the first end of the first arcuate member (102) and the first end of the second arcuate member (108). In an embodiment, the operator or the manufacture may couple the adjustable hinge (114) between the first end of the first arcuate member (102) and the first end of the second arcuate member (108), as described for example, in FIG. 1.

At step (408), the toggle latch clamp (116) may be coupled between the second end of the first arcuate member (102) and the second end of the arcuate member (108). In an embodiment, the operator or the manufacture may couple the adjustable hinge (114) between the second end of the first arcuate member (102) and the second end of the second arcuate member (108), as described for example, in FIG. 1.

The order in which the flowchart (400) is described is not intended to be construed as a limitation, and any number of the described method blocks can be combined in any order to implement the flowchart (400) or alternate methods. Additionally, individual blocks may be deleted from the flowchart (400) without departing from the spirit and scope of the subject matter described herein. Furthermore, the method can be implemented in any suitable hardware, software, firmware, or combination thereof.

The illustrated steps are set out to explain the exemplary embodiments shown, and it may be anticipated that ongoing technological development will change the way particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

The foregoing method descriptions and the process flow diagrams are provided merely as illustrative examples and are not intended to require or imply that the steps of the various embodiments must be performed in the order presented. As may be appreciated by one of skill in the art the order of steps in the foregoing embodiments may be performed in any order. Words such as “thereafter,” “then,” “next,” are not intended to limit the order of the steps; these words are simply used to guide the reader through the description of the methods. Further, any reference to claim elements in the singular, for example, using the articles “a,” “an” or “the” is not to be construed as limiting the element to the singular.

Various embodiments of the present invention are described with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure may satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the feature, structure, or characteristic following the phrase may be included in at least one embodiment of the present disclosure and may be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can,” “may,” “could,” “should,” “would,” “preferably,” “possibly,” “typically,” “optionally,” “for example,” “often,” or “might” (or other such language) be included or have a characteristic, that component or feature is not required to be included or to have the characteristic. Such component or feature may be optionally included in some embodiments, or it may be excluded.

In some example embodiments, certain ones of the operations herein may be modified or further amplified as described below. Moreover, in some embodiments additional optional operations may also be included. It should be appreciated that each of the modifications, optional additions or amplifications described herein may be included with the operations herein either alone or in combination with any others among the features described herein.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

I/We claim:

1. A lifting device (100) to lift a cylindrical container, comprising:
a first arcuate member (102), wherein the first arcuate member (102) is coupled with a first sleeve (104), the first sleeve (104) has a first cut-out at a radial mid-section of the first arcuate member (102), such that, a first handle (106) extends from the radial mid-section of the first arcuate member (102), via the first cut-out of the first sleeve (104);
a second arcuate member (108), wherein the second arcuate member (108) is coupled with a second sleeve (110), the second sleeve (110) has a second cut-out at a radial mid-section of the second arcuate member (108), such that, a second handle (112) extends from the radial mid-section of the second arcuate member (108), via the second cut-out of the second sleeve (110);
an adjustable hinge (114) coupled between a first end of the first arcuate member (102) and a first end of the second arcuate member (108), wherein the adjustable hinge (114) is configured to adjust a swiveling between the first end of the first arcuate member (102) and the first end of the second arcuate member (108); and
a toggle latch clamp (116) coupled between a second end of the first arcuate member (102) and a second end of the second arcuate member (108), wherein the toggle latch clamp (116) is configured to adjust a screw distance between the second end of the first arcuate member (102) and the second end of the second arcuate member (108).

2. The lifting device (100) as claimed in claim 1, wherein the adjusting hinge (114) has a swiveling angle that is in a range between 10 degrees to 90 degrees.

3. The lifting device (100) as claimed in claim 2, wherein one of: the swiveling angle and the screw distance are adjusted based on a dimension of the cylindrical container.

4. The lifting device (100) as claimed in claim 2, wherein both the swiveling angle and the screw distance are adjusted based on a dimension of the cylindrical container.

5. The lifting device (100) as claimed in claim 1, wherein the first arcuate member (102) has a first C-shaped structure, and the second arcuate member (108) has a second C-shaped structure, and when the first arcuate member (102) is coupled with the second arcuate member (108), it forms a substantially circular structure that conforms to a circumference of the cylindrical container.

6. The lifting device (100) as claimed in claim 1, wherein the adjustable hinge (114) is a living hinge, which is formed from a same material as a material one of: the first arcuate member (102) or the second arcuate member (108).

7. The lifting device (100) as claimed in claim 1, wherein the adjustable hinge (114) is formed from a material, which is different from a material of one of: the first arcuate member (102) or the second arcuate member (108).

8. The lifting device (100) as claimed in claim 1, wherein at least one of: the first sleeve (104) or the second sleeve (110), is formed from a same material as a material one of: the first arcuate member (102) or the second arcuate member (108).

9. The lifting device (100) as claimed in claim 1, wherein at least one of: the first sleeve (104) or the second sleeve (110), is formed from a material, which is different from a material of one of: the first arcuate member (102) or the second arcuate member (108).

10. The lifting device (100) as claimed in claim 1, wherein toggle latch clamp (116) has a hook and a tongue-based latch, the hook is configured to receive a tongue-based latch and couple the second end of the first arcuate member (102) with the second end of the second arcuate member (108).

11. The lifting device (100) as claimed in claim 1, wherein the toggle latch clamp (116) is formed from a same material as a material one of: the first arcuate member (102) or the second arcuate member (108).

12. The lifting device (100) as claimed in claim 1, wherein the toggle latch clamp (116) is formed from a material, which is different from a material one of: the first arcuate member (102) or the second arcuate member (108).

13. The lifting device (100) as claimed in claim 1, wherein the first arcuate member (102) is formed from a material that is same as a material of the second arcuate member (108).

14. The lifting device (100) as claimed in claim 1, wherein the first arcuate member (102) is formed from a material that is different from a material of the second arcuate member (108).

15. The lifting device (100) as claimed in claim 1, wherein the adjustable hinge (114) is integrated with at least one of: the first arcuate member (102) or the second arcuate member (108).

16. The lifting device (100) as claimed in claim 1, wherein the toggle latch clamp (116) has a screw-based adjustment mechanism to adjust the screw distance between the first arcuate member (102) and the second arcuate member (108).

17. A method of forming a lifting device (100) to lift a cylindrical container, the method comprising:
disposing a first arcuate member (102), wherein the first arcuate member (102) is coupled with a first sleeve (104), the first sleeve (104) has a first cut-out at a radial mid-section of the first arcuate member (102), such that, a first handle (106) extends from the radial mid-section of the first arcuate member (102), via the first cut-out of the first sleeve (104);
disposing a second arcuate member (108), wherein the second arcuate member (108) is coupled with a second sleeve (110), the second sleeve (110) has a second cut-out at a radial mid-section of the second arcuate member (108), such that, a second handle (112) extends from the radial mid-section of the second arcuate member (108), via the second cut-out of the second sleeve (110);
coupling an adjustable hinge (114) between a first end of the first arcuate member (102) and a first end of the second arcuate member (108), wherein the adjustable hinge (114) is configured to adjust swiveling between the first end of the first arcuate member (102) and the first end of the second arcuate member (108); and
coupling a toggle latch clamp (116) between a second end of the first arcuate member (102) and a second end of the second arcuate member (108), wherein the toggle latch clamp (116) is configured to adjust a screw distance between the second end of the first arcuate member (102) and the second end of the second arcuate member (108).
